(19) United States
(12) Patent Application Publication
(10) Pub. No.: US 2026/0111280 A1
(43) Pub. Date: Apr. 23, 2026

(54) Adaptive Request Grouping Based On Node Pool Impact

(71) Applicant: NetApp, Inc., San Jose, CA (US)

(72) Inventors: Idan Schwartz, Tel Aviv (IL); Roi Kramer, Ramat Gan (IL); Shani Jacobson, Tel Aviv (IL); Ido Haskel, Kiryat Ono (IL); Tal Shmuel Shafir, Yavne (IL); Tal Ohayon, Tel Aviv (IL); Oren Gurfinkel, Rishon Le Zion (IL); Eirikur Sveinn Hrafnsson, Reykjavic (IS)

(73) Assignee: NetApp, Inc., San Jose, CA (US)

(21) Appl. No.: 18/924,118

(22) Filed: Oct. 23, 2024

(51) Int. Cl. G06F 9/50; G06F 11/14

(52) U.S. Cl. CPC G06F 9/505; G06F 11/1451

(57) ABSTRACT

The disclosure describes a node management service that groups pods based on an impact of the available instance pool. The node management service identifies a request group associated with a scale-up request to scale up a cluster of compute nodes to host pods in the request group. The node management service iteratively determines to add pods to the request group until an impact of a next pod on a pool of available nodes exceeds a threshold. The node management service sends a request to a distributor to distribute the pods in the request group to one or more nodes obtained from the pool of available nodes.

### BACKGROUND

As workloads running in a compute cluster scale up, a node management service provisions additional nodes to accommodate large workload requests. In cloud environments, compute clusters often rely on a combination of on-demand, spot, and reserved instances for nodes to balance cost and availability. The goal is to optimize resource allocation while keeping costs down. Current approaches to scaling typically rely on a pod queue, where pending pods are iteratively grouped together and assigned to a single node as long as there is an available instance in the market that can accommodate a node with the requested pods. This process is driven by the need to quickly scale resources when receiving large scale-up requests.

However, this approach frequently results in the use of fewer, larger nodes, which introduces significant issues. If one of these large nodes is interrupted, especially when using spot instances, which are prone to unexpected termination, the disruption can be considerable. Additionally, cost inefficiencies arise when pods with varying resource requirements are grouped together on the same node. For example, a pod that requires an expensive on-demand instance may be placed alongside pods that could run on cheaper spot instances, or a pod that requires expensive resources (e.g., GPU) could be placed alongside pods that do not require these resources, unnecessarily inflating operational costs. Furthermore, as more pods are grouped onto a single node, the system has fewer instance types and configurations to choose from, further limiting flexibility and reducing the opportunity to optimize cost and availability.

### SUMMARY

The disclosure describes a node management service that identifies a request group associated with a scale-up request. The node management service iteratively determines to add pods to the request group until an impact of a next pod on a pool of available instances exceeds a threshold. The node management service then sends a request to a distributor to distribute the pods in the request group to one or more nodes obtained from the pool of available instances. Accordingly, the node management service splits a scale-up request into smaller requests for scaling up nodes, thus alleviating the above-described issues.

### BRIEF DESCRIPTION OF THE DRAWINGS

FIG. 1 illustrates a computing environment in an implementation.

FIG. 2 illustrates another view of the computing environment in an implementation.

FIG. 3 illustrates a request grouping process in an implementation.

FIG. 4 illustrates an operational sequence in an implementation.

FIG. 5 illustrates a computing system suitable for implementing the various operational environments, architectures, environments, processes, scenarios, sequences, and frameworks discussed below with respect to the other Figures.

### DETAILED DESCRIPTION

The disclosure describes a node management service that, upon receiving large-scale requests from a control plane (e.g., Kubernetes), breaks these requests into smaller request groups to send to the distributor. To organize pods into groups, the node management service calculates a virtual node potential for an available instance pool, which consists of possible instances provided by a compute provider, such as Amazon Web Services, that can meet the resource requirements for accommodating a node running the group of pods. These requirements typically include compute capacity (e.g., CPU and memory) and may also involve specific constraints, such as certain pods requiring an on-demand instance. The virtual node potential serves as a metric that indicates the quality of choice with respect to the available options for selecting which node to scale up. In some implementations, determining the virtual node potential involves considering factors such as the number of available options, their cost, and an availability score that reflects the likelihood of node interruptions.

The node management service iteratively adds pods to a request group until the change in virtual node potential, caused by adding the next pod, exceeds a predefined threshold. For instance, adding a new pod may significantly reduce the number of instance types capable of supporting the group, due to some instances no longer having sufficient CPU or memory capacity. This reduction in available instances would cause a substantial change in the virtual node potential, exceeding the threshold. At this point, the node management service submits the current request group to the distributor for node scale-up, and the next pod is allocated to a new request group. By breaking large requests into smaller, more manageable groups, the node management service ensures the distributor has a healthy range of instance options available for selection.

Various embodiments of the present technology provide for a wide range of technical effects, advantages, and/or improvements to computing systems and components. For example, various embodiments may include one or more of the following technical effects, advantages, and/or improvements: 1) non-routine and unconventional dynamic implementation of a node management service; 2) non-routine and unconventional operations for grouping pods; 3) dynamic modification of a scale-up request, and/or 4) non-routine and unconventional use of cost and availability data.

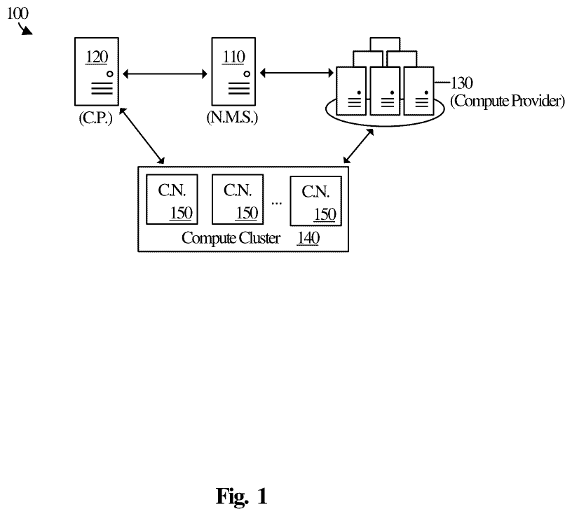

FIG. 1 illustrates computing environment 100 in an implementation. Computing environment 100 includes node management service 110, control plane 120, compute provider 130, and compute cluster 140. Node management service 110 is in communication with control plane 120 and compute provider 130. Control plane 120 is in communication with node management service 110 and compute cluster 140. Compute provider 130 is in communication with node management service 110 and compute cluster 140.

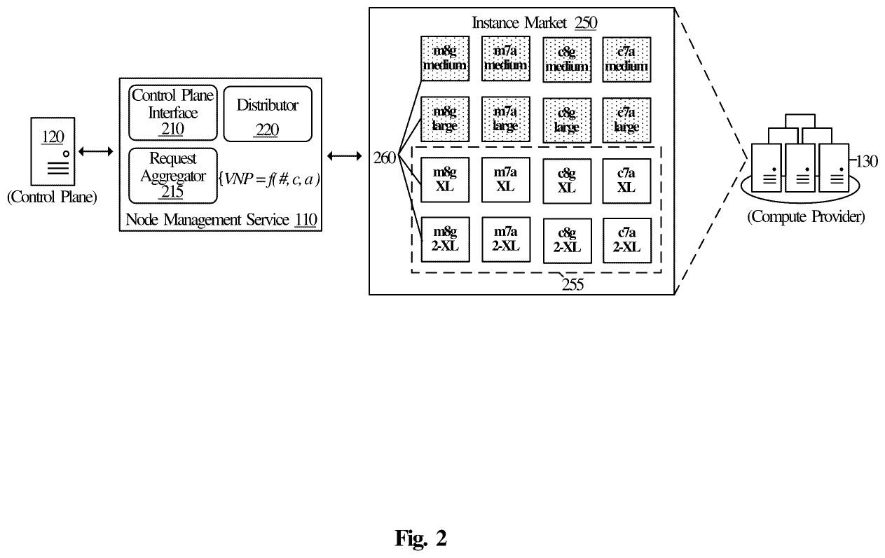

Node management service 110 is representative of a software service that manages compute nodes 150 in compute cluster 140. Node management service 110 may be, for example, Spot Ocean. Node management service 110 may be a cloud-based service utilized by customers running applications in compute cluster 140. Node management service 110 is configured to receive scale-up requests from control plane 120, and to group pods from the scale-up requests based on virtual node potential. This grouping based on virtual node potential ensures that the distributor of node management service 110 has a healthy range of instance selection options, as discussed in further detail in relation to FIG. 2 below.

Control plane 120 is representative of a software service that orchestrates deployment of an application in compute cluster 140. Examples of control plane 120 include Kubernetes, Nomad, and Apache Mesos, among others. Control plane 120 may operate as a cloud-based service or be hosted on a server managed by the customer running applications in compute cluster 140. Control plane 120 is configured to provide the scale-up requests to node management service 110. These scale-up requests may identify workloads with new or unschedulable pods, indicating that new compute nodes 150 need to be scaled up in compute cluster 140. In some cases, these scale-up requests may be massive, e.g., including thousands of new pods to scale up. Node management service 110 breaks these scale-up requests into smaller request groups, as discussed in further detail in FIG. 2 below.

Compute cluster 140 includes compute nodes 150. While three compute nodes 150 are shown in FIG. 1 for convenience, compute cluster 140 may include more compute nodes 150. For example, a compute cluster 140 running a large-scale application may include hundreds or thousands of compute nodes 150. Compute node 150 may be implemented in a virtual machine (an instance) provided by compute provider 130. Compute node 150 runs one or more pods, as well as a node agent (such as Kubelet). Compute node 150 may be selected and obtained by a distributor (such as distributor 220 of FIG. 2) of node management service 110, based on the identified request groups.

Compute provider 130 is representative of a provider of compute resources, including instances for implementation as compute nodes 150 in compute cluster 140. Examples of compute provider 130 include Amazon Web Services, Google Cloud, and IBM Cloud, among others. Compute provider 130 may provide a range of different instance selection options, which node management service 110 may select based on the identified request groups, as discussed further below in the discussion of instance market 250 of FIG. 2.

FIG. 2 illustrates another view of computing environment 100 in an implementation, including node management service 110, control plane 120, and compute provider 130. Computing environment 100 further includes compute cluster 140, which is not shown in FIG. 2 for clarity.

Node management service 110 includes control plane interface 210, request aggregator 215, and distributor 220. Control plane interface 210 is configured to receive scale-up requests from control plane 120. These scale-up requests identify new pods that need to be scheduled to nodes, and in some cases may involve massive requests (e.g., having thousands of pods). The scale-up requests may be generated by control plane 120 due to the deployment of new applications, increased demand for currently running workloads, or when pods need to be rescheduled because a compute node 150 (see FIG. 1) has become unavailable.

Request aggregator 215 is configured to group pods from the scale-up request received by control plane interface 210. Request aggregator 215 groups pods into request groups based on a calculation of virtual node potential, which is a measurement of quality of choice available for selecting an instance from instance market 250.

As illustrated in FIG. 2, instance market 250 may include many potential instances 260 that are offered to customers by compute provider 130. While a selection of potential instances 260 is displayed in FIG. 2 for clarity, compute provider 130 may offer many more different available types of instances. The various potential instances 260 have varying characteristics, including differing amounts of CPU, differing amounts of memory, among other characteristics. Further, some potential instances 260 may be offered as spot instances (which have low availability but come at a low cost) while others are offered as on-demand (which have higher availability but come at a higher cost). The labels (e.g., “m7a medium”, “c7a large”) shown in FIG. 2 represent different configurations of potential instances 260, such as variations in CPU capacity, memory size, and other performance attributes. These labels indicate the type of resources offered by a compute provider (e.g., Amazon Web Services, Google Cloud). The specific labels used in the figures are examples, and the actual configurations may differ depending on the provider or customer requirements.

When identifying the request group, request aggregator 215 identifies potential instances 260 that are capable of running the pods in the request group. In the example in FIG. 2, the larger potential instances 260 are in the available instance pool 255, while smaller potential instances 260 are not in the available instance pool 255 (indicated by the shading of some potential instances 260 in FIG. 2). In this example, the smaller instances may not have sufficient CPU resources to accommodate the pods in the request group, and request aggregator 215 therefore excludes them from available instance pool 255. It is noted that the available instance pool 255 is identified based on potential instances 260 that meet all the requirements of pods in the request group, including CPU, memory, whether any pods have an on-demand requirement, among other parameters.

Accordingly, to calculate the virtual node potential, request aggregator 215 first identifies the available instance pool 255 by identifying potential instances 260 that could potentially accommodate a node running the pods in the request group. Request aggregator 215 may identify available instance pool 255 by identifying each potential instance 260 that meets the requirements for running all the pods in the request group, including resource requirements (e.g., CPU and memory) and other requirements (e.g., pods may require on-demand instances or have specialized resource requirements such as GPU).

In some implementations, request aggregator 215 further evaluates whether a snapshot feature is enabled for the request group to identify available instance pool 255. A customer or application owner may enable the snapshot feature for the request group, for example, through a user interface provided by node management service 110. The snapshot feature provides for snapshot backups and restoration of the applications within the request group such that applications (especially stateful applications) may be restored if an instance is reclaimed by compute provider 130. Request aggregator 255 may refine the selection of potential instances 260 in available instance pool 255 by selecting only those potential instances 260 capable of supporting the snapshot feature (in addition to meeting the other requirements of the request group as set forth above). This selection may include evaluating potential instances 260 to determine if they have the appropriate configurations, such as sufficient memory, storage bandwidth, and a sufficient availability score to maintain uptime long enough to complete snapshot processes without interruption.

In some implementations, request aggregator 215 may further refine the selection of potential instances 260 in available instance pool 255 by incorporating an assessment of the time duration for taking a snapshot of pod within the request group (particularly where the request group includes pods running stateful applications). To accomplish this, request aggregator 215 estimates the snapshot duration based on the memory allocated to the pod (e.g., the minimum amount of memory for running the pod identified in the request value). Given that pods with larger memory allocations typically require more time to snapshot, the system determines the anticipated duration to ensure that the selected instances will have sufficient stability (reflected in the availability score) to complete the operation. Request aggregator 215 establishes a threshold availability score based on the estimated snapshot duration, identifying the minimum level of availability a potential instance 260 must have to be included in available instance pool 255. Potential instances 260 with availability scores below this threshold are excluded from available instance pool 255, as they may not provide sufficient uptime for the snapshot process to complete reliably. This approach enhances the efficiency and reliability of the scaling process by ensuring that only instances capable of meeting the pod's snapshot requirements are included.

After identifying available instance pool 255, request aggregator 215 may use various techniques to calculate virtual node potential. In some implementations, request aggregator 215 calculates the virtual node potential as a function of the number of potential instances 260 in available instance pool 255, the average cost score of these instances, and the average availability score of these instances (where availability is a metric estimating how reliable a potential instance 260 will be based on the likelihood of interruptions). It is noted that the different factors can be weighted differently based on the goals of the customer. For example, a customer that cares more about cost savings than reliability will give the cost metric more weight than availability. FIG. 2 illustrates this calculation as VNP=f [symbol] #,c,α), illustrating that the virtual node potential (VNP) is a function of the number (#) of potential instances 260 in available instance pool 255, the average cost score of these instances (c) and the average availability score of these instances (α).

In other implementations, virtual node potential may combine the cost and availability into an availability-cost metric. In this example, the virtual node potential calculation may be represented by Σcᵢ*αᵢ, where cᵢ represents the cost score for each potential instance 260 in available instance pool 255 and aᵢ represents the availability score for each potential instance 260 in available instance pool 255. An advantage of this combined metric is that a change in cost of potential instances 260 with low availability may not significantly change the virtual node potential, noting that distributor 220 may be unlikely to choose a potential instance 260 with low availability. Thus, the weighted metric provides that potential instances 260 with a higher chance of being selected by distributor 220 have a greater influence on the calculated virtual node potential.

In yet another implementation, the virtual node potential may simply be the number of potential instances 260 in available instance pool 255. It is noted that in various implementations, various other metrics may be utilized in the virtual node potential calculation. The overall goal is to create a request group that gives distributor 220 a quality distribution of choice in its decision-making, where some or all of: the number of choices, the cost-effectiveness of the choices, and the reliability of the choices may all affect the quality of choice.

As a preliminary to the virtual node potential calculation, request aggregator 215 may estimate the cost score and availability score of each potential instance 260 in available instance pool 255 (in order to perform average-based calculation or the weighted-metric calculation discussed above). Request aggregator 215 utilizes various factors to estimate the cost and availability, including price listings, historical cost data, historic reliability data, geographic location where the node will be deployed, and time and date, among other considerations. In some implementations, machine-learning techniques may be used to estimate cost scores and availability scores of potential instances 260.

Scale-up requests obtained by control plane interface 210 may include a large number of pods to scale up. Request aggregator 215 splits the pods from the scale-up requests into request groups, each of which is separately provided to distributor 220 for node scale-up. To create the request groups, request aggregator 215 first identifies a request group. It then iteratively determines to add pods to the request group until an impact of a next pod on a pool of available nodes exceeds a threshold. In particular, request aggregator 215 calculates the virtual node potential of the request group with the next pod, then determines a chance in virtual node potential resulting from adding the next pod (i.e., a difference between the calculated virtual node potential with the calculated virtual node potential for the previous iteration). In some cases, adding the next pod could cause a significant number of potential instances 260 to drop out of available instance pool 255. For example, upon adding the next pod, the “XL” potential instances 260 might no longer have sufficient CPU to accommodate the request group; in this case, the “XL” potential instances 260 would drop out of available instance pool 255, which would significantly decrease virtual node potential, causing the change in virtual node potential to exceed the threshold. In this case, request aggregator 215 sends the request group (without the next pod) to distributor 220 for scale-up, adds the next pod to a new request group, and repeats the process with the new request group.

Distributor 220 is configured to scale-up nodes in compute cluster 140 (see FIG. 1), from instance market 250, based on request groups received from request aggregator 215. The goal of distributor 220 is to balance cost efficiency and availability when selecting nodes. Typically, distributor 220 selects one node from the available instance pool 255 that meets the needs of the request group, while balances cost and availability considerations. However, in cases where the request group exceeds the capacity of a single node, distributor 220 may select multiple nodes to efficiently distribute the workload.

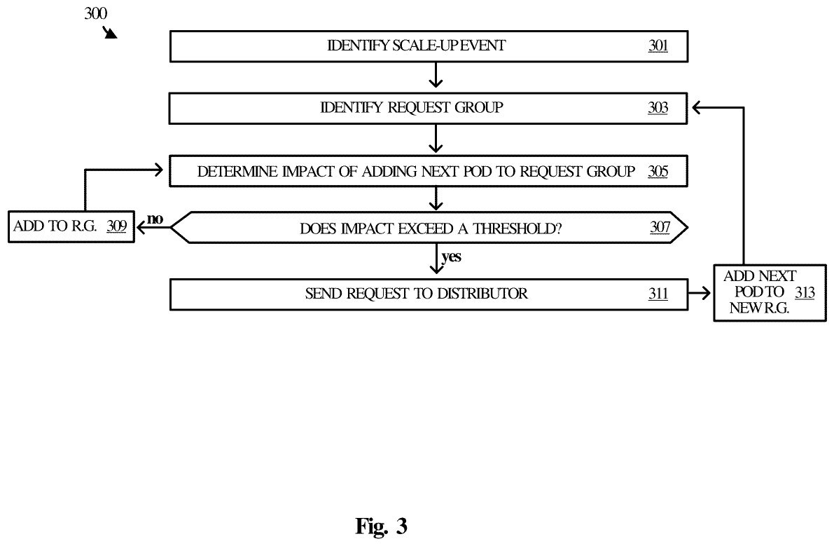

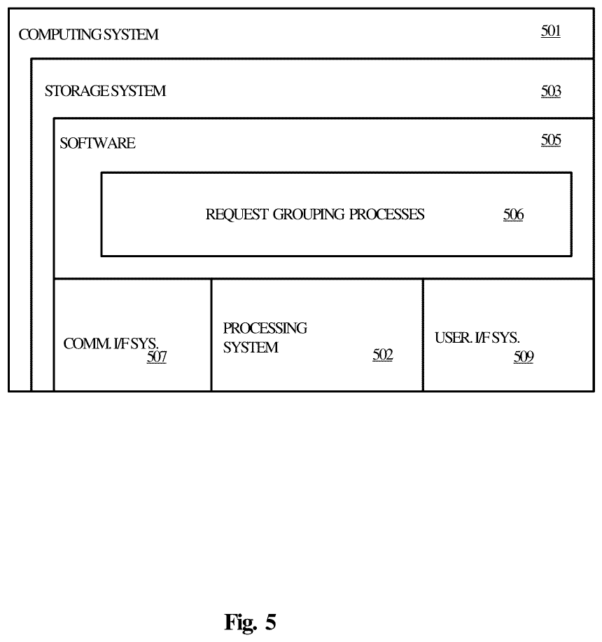

FIG. 3 illustrates a node scaling process performed by node management service 110, represented by process 300. Process 300 is employed by a computing device to provide node scaling, an example of which is provided by computing system 501 of FIG. 5. Process 300 may be implemented in program instructions (software and/or firmware) by one or more processors of the computing device. The program instructions direct the computing device to operate as follows, referring parenthetically to the steps in FIG. 3.

Node management service 110 identifies a scale-up event (step 301). The scale-up event may be a scale-up request, received from control plane 120, that identifies pods (in some cases, a large number of pods) to scale up in compute cluster 140.

Node management service 110 identifies a request group (step 303). The request group includes a subset of pods from the scale-up request to provide in a smaller request to distributor 220. In some instances, the request group may start with one pod, where pods are iteratively added until a threshold is exceeded, as discussed below.

Node management service 110 determines the impact of adding a next pod to the request group (step 305). In particular, node management service 110 calculates a change in virtual node potential resulting from adding the next pod to the request group and determines a change in virtual node potential (i.e., from that of the initial request group or previous iteration). The calculation of virtual node potential is discussed in detail above in relation to FIG. 2 above.

Node management service 110 determines if the impact exceeds a threshold (step 307). In particular, node management service 110 determines if the determined change in virtual node potential exceeds a threshold. This threshold may be predetermined to correspond to a reduction in the virtual node reduction indicating a significant reduction in the quality of choice available in available instance pool 255.

If the impact does not exceed a threshold, node management service 110 adds the pod to the request group (step 309). Process 300 then returns to step 305 where the impact of adding a next pod is determined. As such, node management service 110 iteratively adds pods to the request group until the impact exceeds a threshold.

Upon determining (at step 307) that the impact of adding the next pod does exceed the threshold, node management service 110 (in particular, request aggregator 215) sends a request including the request group (without the next pod) to distributor 220 (step 311). Node management service 110 adds the next pod to a new request group (step 313), and process 300 returns to step 303 with the identification of the new request group (step 303). Thus, process 300 includes the iterative creation of request groups and grouping of pods until all pods from the scale-up event (of step 301) have been added to a request group and sent to distributor 220 (at step 311). Thus, while the scale-up event of step 301 may include one received scale-up request from control plane 120, request aggregator 215 splits this scale-up request into multiple request groups to send to distributor 220. Distributor 220 scales up a node from available instance pool 255 for deployment of each request group to compute cluster 140.

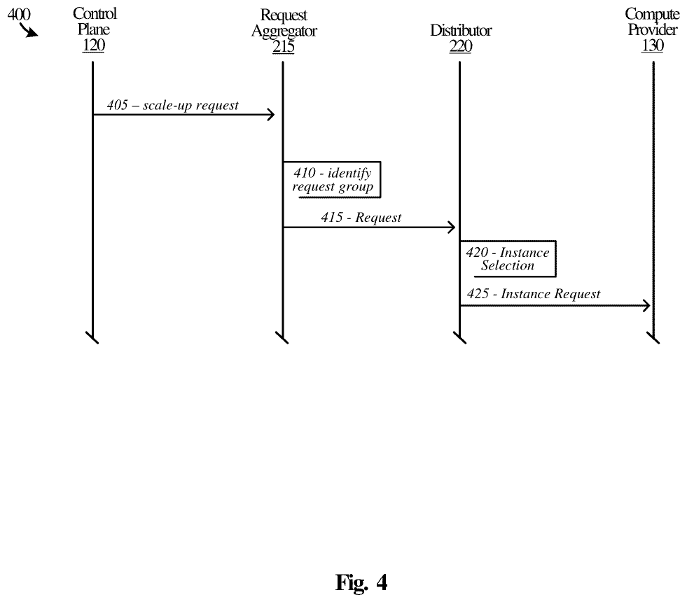

FIG. 4 illustrates an operation sequence of an application of process 300 in the context of compute environment 100 in an implementation, represented by sequence 400. Sequence 400 includes control plane 120, request aggregator 215, distributor 220, and compute provider 130.

At operation 405, control plane 120 provides a scale-up request to request aggregator 215 (via control plane interface 210 of FIG. 2). At operation 410, request aggregator 215 identifies a request group and groups pods from the scale-up request into the request group (as discussed above with respect to steps 303-307 of process 300). At operation 415, request aggregator 215 provides a request including the request group to distributor 220. At operation 420, distributor 220 selects a potential instance 260 (see FIG. 2) for running the request group in compute cluster 140 (see FIG. 1). At operation 425, distributor 220 submits a request for the selected instance to compute provider 130. In response to the instance request, compute provider 130 deploys the instances to compute cluster 140 (see FIG. 1), and control plane 120 proceeds to deploy the pods to compute cluster 140. It is noted that operations 410-425 may be performed iteratively, since the initial scale-up request may be split into multiple request groups by request aggregator 215.

FIG. 5 illustrates computing system 501, which is representative of any system or collection of systems in which the various applications, processes, services, and scenarios disclosed herein may be implemented. Examples of computing system 501 include, but are not limited to server computers, web servers, cloud computing platforms, and data center equipment, as well as any other type of physical or virtual server machine, container, and any variation or combination thereof. (In some examples, computing system 501 may also be representative of desktop and laptop computers, tablet computers, and the like).

Computing system 501 may be implemented as a single apparatus, system, or device or may be implemented in a distributed manner as multiple apparatuses, systems, or devices. Computing system 501 includes, but is not limited to, processing system 502, storage system 503, software 505, communication interface system 507, and user interface system 509. Processing system 502 is operatively coupled with storage system 503, communication interface system 507, and user interface system 509.

Processing system 502 loads and executes software 505 from storage system 503. Software 505 includes and implements request grouping processes 506, which is representative of the processes discussed with respect to the preceding figures, such as process 300. When executed by processing system 502, software 505 directs processing system 502 to operate as described herein for at least the various processes, operational scenarios, and sequences discussed in the foregoing implementations. Computing system 501 may optionally include additional devices, features, or functionality not discussed for purposes of brevity.

Referring still to FIG. 5, processing system 502 may include a microprocessor and other circuitry that retrieves and executes software 505 from storage system 503. Processing system 502 may be implemented within a single processing device but may also be distributed across multiple processing devices or sub-systems that cooperate in executing program instructions. Examples of processing system 502 include general purpose central processing units, microcontroller units, graphical processing units, application specific processors, integrated circuits, application specific integrated circuits, and logic devices, as well as any other type of processing device, combinations, or variations thereof.

Storage system 503 may comprise any computer readable storage media readable by processing system 502 and capable of storing software 505. Storage system 503 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 503 may be implemented as a single storage device but may also be implemented across multiple storage devices or sub-systems co-located or distributed relative to each other. Storage system 503 may comprise additional elements, such as a controller capable of communicating with processing system 502 or possibly other systems.

Software 505 (including request grouping processes 506) may be implemented in program instructions and among other functions may, when executed by processing system 502, direct processing system 502 to operate as described with respect to the various operational scenarios, sequences, and processes illustrated herein. For example, software 505 may include program instructions for implementing request grouping processes and procedures as described herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method for operating a node management service comprising:
identifying a request group associated with a scale-up request to scale up a cluster of compute nodes to host pods in the request group;
iteratively determining to add pods to the request group until an impact of a next pod on a pool of available instances exceeds a threshold; and
sending a request to a distributor to distribute the pods in the request group to one or more nodes obtained from the pool of available instances.

2. The method of claim 1 further comprising: identifying the impact of the next pod on the pool of available instances by:
identifying the pool of available instances by identifying each potential instance that is capable of running the request group with the next pod;
calculating a virtual node potential associated with the pool of available instances, wherein the virtual node potential indicates a quality of choice available for selecting an instance from the pool; and
determining a change in the virtual node potential from a previous virtual node potential.

3. The method of claim 2, wherein the calculating the virtual node potential comprises:
identifying an average availability score and an average cost score for instances in the pool; and
calculating the virtual node potential based on the average availability score, the average cost score, and a number of instances in the pool.

4. The method of claim 2, wherein the calculating the virtual node potential comprises:
identifying cost score and an availability score for each instance in the pool of available instances; and
calculating the virtual node potential by adding together a product of the cost score and availability score for each instance in the pool.

5. The method of claim 2, wherein the calculating the virtual node potential comprises:
identifying a number of instances in the pool of available instances, wherein the virtual node potential is the number of the instances in the pool.

6. The method of claim 2, wherein the identifying the pool of available instances comprises:
estimating a duration for taking a snapshot of a pod in the request group based on an amount of memory allocated to the pod; and
identifying a threshold availability score for instances to include in the pool based on the estimated duration.

7. The method of claim 2, wherein the identifying the pool of available instances comprises:
identifying that a snapshot feature is enabled for the request group, wherein the snapshot feature provides snapshot backups of applications in the request group for restoration; and
identifying potential instances that are capable of supporting the snapshot feature.

8. The method of claim 1, further comprising, upon identifying that the impact of the next pod on the pool of available instances exceeds the threshold:
identifying a new request group;
adding the next pod to the new request group; and
iteratively determining to add additional pods to the request group until the impact of a next additional pod on the pool of available instances exceeds the threshold.

9. A system comprising:
one or more processors; and
one or more memories operably coupled to the one or more processors and having stored thereon software instructions that, upon execution by the one or more processors, cause the one or more processors to:
identify a request group associated with a scale-up request to scale up a cluster of compute nodes to host pods in the request group;
iteratively determine to add pods to the request group until an impact of a next pod on a pool of available instances exceeds a threshold; and
send a request to a distributor to distribute the pods in the request group to one or more nodes obtained from the pool of available nodes.

10. The system of claim 9, wherein the software instructions comprise further instructions that, upon execution by the one or more processors, cause the one or more processors to:
identify the pool of available instances by identifying each potential instance that is capable of running the request group with the next pod;
calculate a virtual node potential associated with the pool of available instances, wherein the virtual node potential indicates a quality of choice available for selecting an instance from the pool; and
determine a change in the virtual node potential from a previous virtual node potential.

11. The system of claim 10, wherein the calculating the virtual node potential comprises:
identifying an average availability score and an average cost score for instances in the pool; and
calculating the virtual node potential based on the average availability score, the average cost score, and a number of instances in the pool.

12. The system of claim 10, wherein the calculating the virtual node potential comprises:
identifying cost score and an availability score for each instance in the pool of available instances, and
calculating the virtual node potential by adding together a product of the cost score and availability score for each instance in the pool.

13. The system of claim 10, wherein the calculating the virtual node potential comprises:
identifying a number of instances in the pool of available instances, wherein the virtual node potential is the number of the instances in the pool.

14. The system of claim 10, wherein the identifying the pool of available instances comprises:
estimating a duration for taking a snapshot of a pod in the request group based on an amount of memory allocated to the pod; and
identifying a threshold availability score for instances to include in the pool based on the estimated duration.

15. The system of claim 10, wherein the identifying the pool of available instances comprises:
identifying that a snapshot feature is enabled for the request group, wherein the snapshot feature provides snapshot backups of applications in the request group for restoration; and
identifying potential instances that are capable of supporting the snapshot feature.

16. The system of claim 9, wherein the software instructions comprise further instructions that, upon execution by the one or more processors, cause the one or more processors to, upon identifying that the impact of the next pod on the pool of available instances exceeds the threshold:
identify a new request group;
add the next pod to the new request group; and
iteratively determining to add additional next pods to the request group until the impact of a next additional pod on the pool of available instances exceeds the threshold.

17. A computer-readable storage media device having program instructions stored thereon that, upon execution by one or more processors, cause the one or more processors to:
identify a request group associated with a scale-up request to scale up a cluster of compute nodes to host pods in the request group;
iteratively determine to add pods to the request group until an impact of a next pod on a pool of available instances exceeds a threshold; and
send a request to a distributor to distribute the pods in the request group to one or more nodes obtained from the pool of available instances.

18. The computer-readable storage media device of claim 17, wherein the program instructions comprise further instructions that, upon execution by the one or more processors, cause the one or more processors to:
identify the pool of available instances by identifying each potential instance that is capable of running the request group with the next pod;
calculate a virtual node potential associated with the pool of available nodes, wherein the virtual node potential indicates a quality of choice available for selecting an instance from the pool; and
determine a change in the virtual node potential from a previous virtual node potential.

19. The computer-readable storage media device of claim 18, wherein the calculating the virtual node potential comprises:
identifying an average availability score and an average cost score for instances in the pool; and
calculating the virtual node potential based on the average availability score, the average cost score, and a number of instances in the pool.

20. The computer-readable storage media device of claim 17, wherein:
the scale-up request identifies a plurality of pods to scale up in the cluster, and
the request group includes a portion of the plurality of pods.
